(19) United States
(12) Patent Application Publication
(10) Pub. No.: US 2015/0330295 A1
(43) Pub. Date: Nov. 19, 2015

(54) Planetary Gear Set To Provide Speed Control For Belt-Driven Engine Accessory

(71) Applicant: Southwest Research Institute, San Antonio, TX (US)

(72) Inventors: Mark Walls, San Antonio, TX (US); Manfred Amann, San Antonio, TX (US)

(21) Appl. No.: 14/277,155

(22) Filed: May 14, 2014

(51) Int. Cl. F02B 67/06; F16H 59/74; F02B 67/10; F16H 37/08; F16H 3/72

(52) U.S. Cl. CPC F02B 67/06; F16H 37/0806; F16H 3/728; F02B 67/10; F16H 59/74; F16H 2200/2005

(57) ABSTRACT

A method of controlling the operating speed of an engine accessory driven by a belt connected to an engine crankshaft. A planetary gear set is interposed between the belt and the accessory, the planetary gear set having a planet gear carrier, at least one planet gear, a sun gear, and a ring gear. The sun gear is connected to an input mechanism of the accessory. The planet gear carrier is connected to the belt, via a pulley. The ring gear is connected to a generator. An excitation current is applied to the generator, which loads and slows the ring gear. This excitation current can be varied to provide a desired operating speed of the accessory.

### TECHNICAL FIELD OF THE INVENTION

This invention relates to engine accessories, and more particularly controlling superchargers and other belt-driven engine accessories.

### BACKGROUND OF THE INVENTION

In an internal combustion engine, air boosting devices such as turbochargers and superchargers are used for forced induction of air into the engine. They compress the air flowing into the engine, which allows the engine to deliver more air into a cylinder. This in turn, allows the cylinder to receive more fuel, and the increases air and fuel results in more power from each combustion event in the cylinder.

A turbocharger is powered by a turbine, which is driven by the engine's exhaust. A supercharger is powered mechanically by belt-drive or chain-drive from the engine's crankshaft. For example, a supercharger can be driven by an accessory belt, which wraps around a pulley that is connected to a drive gear. The drive gear, in turn, rotates the compressor gear. A rotor draws air in, compresses the air into a smaller space and discharges it into the intake manifold.

Other engine accessories can also be driven by an engine's front accessory belt. Examples of these devices are alternators, water pumps, cooling fan, air conditioning compressors, and power steering pumps.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an engine having a front belt that drives various engine accessories.

FIG. 2 illustrates a planetary gear set interposed between an engine belt and a supercharger.

FIG. 3 schematically illustrates the planetary gear set and its connections.

FIG. 4 illustrates the system of FIG. 2 with an electric motor.

### DETAILED DESCRIPTION OF THE INVENTION

The following invention is directed to coupling a planetary gear set with an electric generator for the purpose of controlling a supercharger or other “belt-driven” accessory of an engine. Typical applications are expected to be for automotive vehicles having internal combustion engines, motors, or hybrid systems. The term “engine” is used herein in a broad sense to include various machines capable of rotating a belt to drive an accessory device. Examples of “accessory devices” are water pumps, radiator fans, alternators, superchargers and other air boosting devices, power steering pumps, and air conditioning compressors. In further embodiments, the planetary gear set may be coupled with both an electric generator and an electric motor.

In today's vehicles, these accessories are driven by the engine's “front belt”, which may be also referred to as an “accessory belt”, “serpentine belt” or “fan belt”. These terms refer to various belts that wind around the engine's crankshaft pulley and one or more additional pulleys. As the engine's crankshaft turns, the belt drives one or more of the above-described engine accessories. In some vehicles, different belts drive different accessories. In other vehicles, a single serpentine belt winds around to drive multiple accessories.

As explained below, the planetary gear set, coupled to a generator, is used in a manner that provides continuously variable operating speeds for the engine accessory. More specifically, the generator is activated with a variable current (excitation current), which in turn varies the speed ratio of the planetary gear set. The planetary gear set thereby operates as a continuously variable transmission that controls the input speed of the accessory.

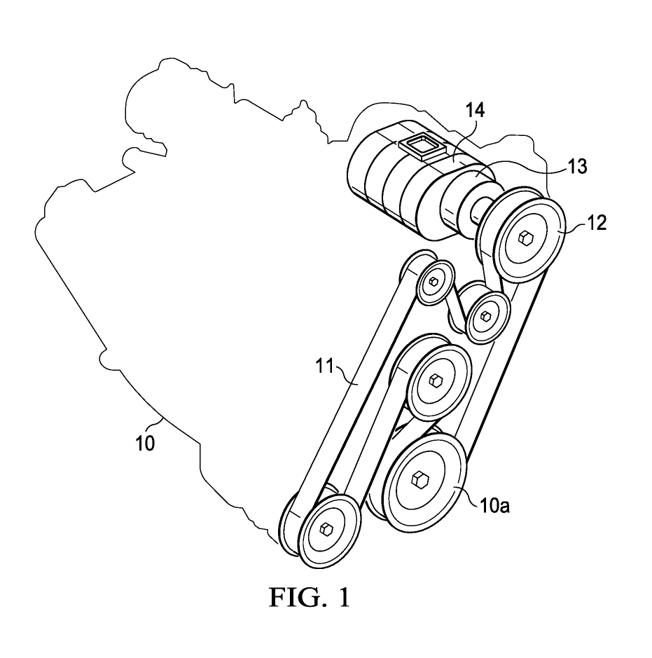

FIG. 1 illustrates an engine 10 having a serpentine type front belt 11. Belt 11 is driven by the engine's crankshaft via a crankshaft pulley 10a. Belt 11, in turn, drives various engine accessories, via a pulley associated with each accessory.

For purposes of example, this description is in terms of a belt-driven supercharger 14. Thus, belt 11 is connected to a pulley 12 associated with the supercharger 14. The supercharger's pulley 12 is connected to a planetary gear set 13, which transmits the driving force of the belt to the supercharger 14. The supercharger 14 is thereby powered, and delivers compressed air to the combustion chambers of the engine cylinders.

Supercharger 14 may be any one of various types of superchargers, and in the example of this description, is a roots type supercharger. Examples of other types of superchargers are centrifugal and turn screw superchargers.

The planetary gear set 13 is interposed between the pulley 12 and the supercharger 14. As explained herein, planetary gear set 13 provides continuously variable control of the engine-to-supercharger speed ratio. The operating speed of the supercharger 14 can be controlled by controlling the planetary gear set 13. The drive speed of the supercharger is independent of the engine speed.

However, as indicated above, it should be understood that the same concepts apply to controlling the operating speed of other belt-driven engine accessories. For other accessories, the planetary gear set 13 would be interposed between that accessory and the pulley associated with that accessory.

Not referring to FIG. 1, conventional belt-driven superchargers have a fixed gear ratio between the engine crankshaft and the supercharger input shaft. In other words, they do not have the planetary gear set 13 of FIG. 1. Due to this fixed gear ratio, boost pressure is typically controlled through a supercharger bypass. The bypass allows some of the flow provided by the supercharger to be diverted from the engine cylinders. During part-load engine operating conditions where only limited amounts of boost is needed, some of the flow provided by the supercharger is sent to the bypass. A problem with using a bypass is that it results in power losses that significantly impact the total power consumption of the supercharger and, thus, reduce engine efficiency.

To eliminate the bypass losses of fixed gear superchargers, efforts have been made to modify the supercharger-to-belt connection with some sort of variable transmissions. For example, one approach is to directly vary the pulley ratio of the supercharger pulley.

Referring again to FIG. 1, and as indicated above, this description is directed to providing a variable transmission with the planetary gear set 13. This configuration offers good transmission efficiency and allows variable speed control of the supercharger without the losses associated with conventional continuously variable transmissions.

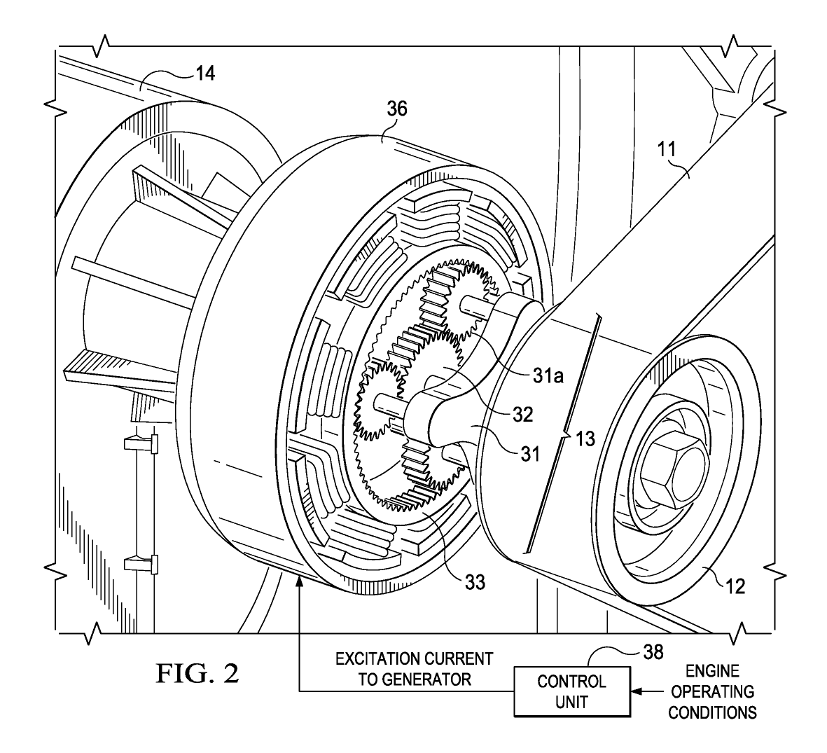

FIG. 2 illustrates the supercharger 14 (shown in part) of FIG. 1, and shows the planetary gear system 13 in further detail. As described above, supercharger 14 is belt-driven, with belt 11 translating the rotation of the engine crankshaft to the planetary gear set 13 via a pulley 12. An electric generator 36 is also shown.

The basic components of a planetary gear set are a central sun gear 32, a planet carrier 31 and its planet gear(s) 31a, and an annulus (ring) gear 33. The planet carrier 31 holds one or more planet gears 31a, which are peripheral to and meshed with the sun gear 32. The annulus (ring) gear 33 is an outer ring with inward-facing teeth that mesh with the planet gear(s) 31a.

In operation, the carrier 31 rotates to carry the planet gear(s) 31a around the sun gear 32. The ring (outer) gear 33 meshes with the planet gear(s). The planet and sun gears mesh so that their pitch circles roll without slip.

In the configuration of FIG. 1, belt 11 (via input pulley 12) rotates the carrier gear 31. The supercharger 14, via an input shaft or other input mechanism, is connected to the sun gear 32. Generator 36 rotates the ring gear 33.

Thus, input rotation from the engine is provided to the planetary gear carrier 31. Output rotation to the supercharger 14 is produced from the sun gear 31. As explained below, gear speed ratio control is provided by using generator 36 to load the ring gear 33.

Generator 36 is of the type that receives an excitation current. The speed ratio of the engine 10 to supercharger 14 can be continuously varied by controlling the excitation current to the generator 36. The variation in excitation current causes variation in the gear speed ratio of the planetary gear set. The amount of variation depends on the layout of the planetary gear set 13, but an example of a range of gear speed ratios is 0:1 to 10:1.

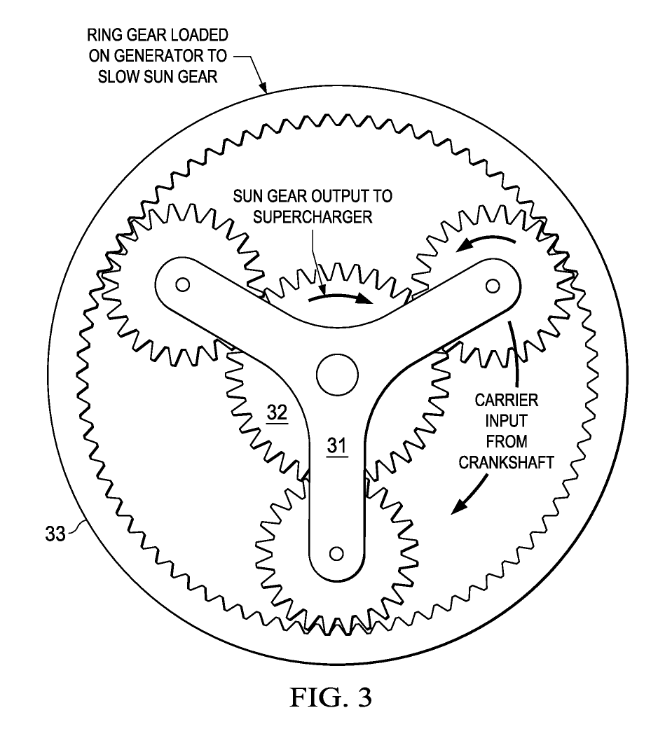

FIG. 3 schematically illustrates the planetary gear set and its connections. Referring to both FIGS. 2 and 3, when the engine is in operation, the engine crankshaft, via belt 11 and pulley 12, rotates the planet gear carrier 31.

Generator 36 controls the rotational speed of the ring gear 33. If no excitation is applied to the generator 36, the ring gear 33 is not loaded and rotates in response to the rotation of the carrier via the planetary gears. The sun gear, which is connected to the input shaft of the supercharger is at or near a standstill. However, if an excitation current is applied to the generator, the ring gear 33 slows causing rotational speed and power from the planet gear carrier to be transferred to the sun gear. This causes the sun gear and supercharger to rotate. By modulating the excitation of the generator 36, the speed of the ring gear and, thus, the speed of the sun gear 32 and supercharger 14 can be controlled proportionally to the amount of excitation current applied to the generator 36.

The same concepts apply to accessories other than a supercharger. The sun gear 32 is attached to a drive shaft or similar input mechanism of the accessory. Operating speed control of these accessories can be controlled by controlling the excitation current to the generator 36.

Referring again to FIG. 2, a control unit 38 provides the excitation current to generator 36. Control unit 38 is processor based and has appropriate hardware and software to perform the tasks described herein. It may be part of a larger control system that performs other engine-related or vehicle-related control tasks.

The inputs to control unit 38 depends on the accessory being controlled. For controlling a supercharger, the inputs typically include engine operating conditions, such as engine load. In general, the lower the engine load, the less boost air is required, and the slower the operating speed of the supercharger. Other inputs for other accessories might include passenger input for air conditioning, engine temperature for a fan or water pump, etc. These inputs are collectively and generally referred to herein as “engine operating conditions”.

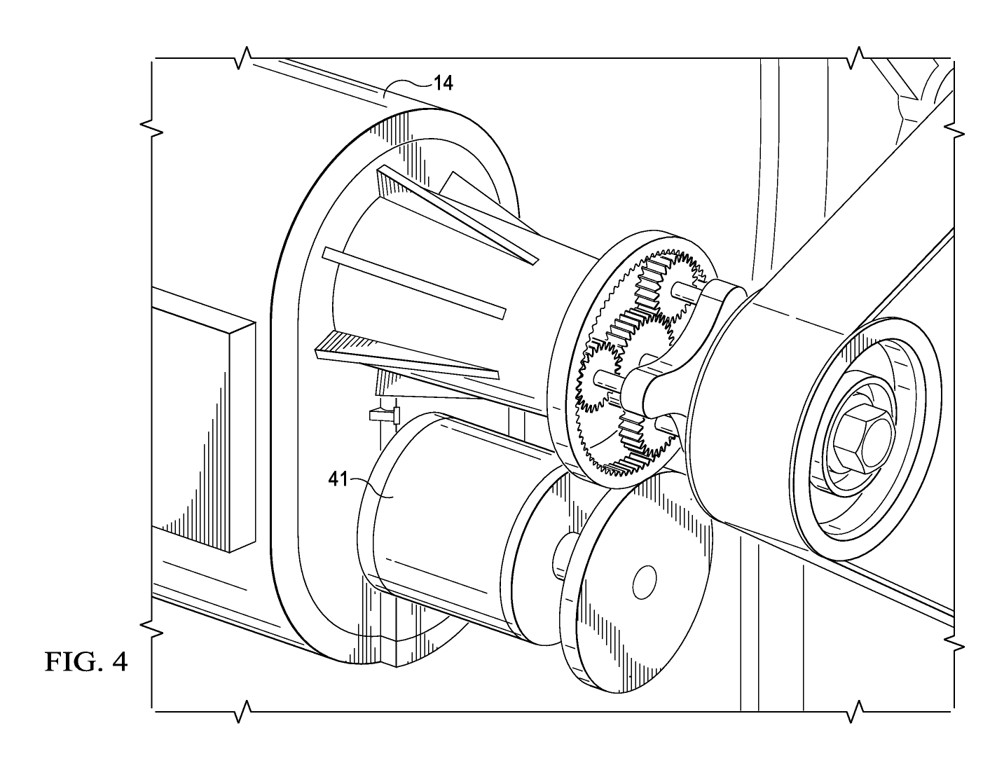

To exploit the electrical energy provided by the generator, a small electric motor can be connected to the supercharger (via the sun gear) to assist in driving the supercharger (or other accessory). In FIG. 4, this configuration is implemented as a motor/generator 41 connected in parallel to the driven input shaft of the accessory (supercharger 14).

The motor, solely powered by the generator, reduces the reaction load from the accessory and minimizes the size required for the motor/generator combination 41. The power supplied to the accessory by the motor, by reducing the reaction load through the planetary gear set, results in reduced power requirements from the generator on the ring gear. Additionally, the use of a motor ensures that the generated power from the generator can be consumed.

Referring again to FIG. 2, alternatively, the electric motor 41 can be omitted and the electrical power provided by the generator 36 can be used to assist in charging an onboard battery (not shown). For example, generator 36 could be used to charge a 12 volt battery of the type typically used in motor vehicles.

What is claimed is:

1. A method of controlling, during operation of an engine, the operating speed of an engine accessory driven by a belt connected to the engine's crankshaft, comprising:
interposing a planetary gear set between the belt and the accessory, the planetary gear set having a planet gear carrier, at least one planet gear, a sun gear, and a ring gear;
connecting the sun gear to an input mechanism of the accessory;
connecting the planet gear carrier to the belt, via a pulley;
connecting the ring gear to a generator;
applying an excitation current to the generator; and
varying the excitation current to provide a desired operating speed of the accessory.

2. The method of claim 1, wherein the varying step is performed such that the desired operating speed is continuously variable.

3. The method of claim 1, further comprising receiving data representing engine conditions, and wherein the varying step is performed in response to the receiving step.

4. The method of claim 1, wherein the accessory is an air boosting device.

5. The method of claim 1, wherein the accessory is one or more of the following: water pump, radiator fan, alternator, power steering pump, or air conditioning compressor.

6. The method of claim 1, further comprising connecting an electric motor to the sun gear.

7. The method of claim 6, further comprising using the electric motor to assist in powering the accessory.

8. The method of claim 1, further comprising using the generator to charge a battery.

9. The method of claim 1, wherein the engine is an internal combustion engine and the belt is a front belt of the engine.

10. A variable transmission for controlling, during operation of an engine, the operating speed of an engine accessory driven by a belt connected to the engine's crankshaft, comprising:
a planetary gear set interposed between the belt and the accessory, the planetary gear set having a planet gear carrier, at least one planet gear, a sun gear, and a ring gear;
an electric generator;
wherein the sun gear is connected to an input mechanism of the accessory;
wherein the planet gear carrier is connected to the belt, via a pulley;
wherein the ring gear is connected to the generator; and
a control unit operable to apply an excitation current to the generator and to vary the excitation current to provide a desired operating speed of the accessory.

11. The transmission of claim 10, wherein the control unit is further operable to vary the excitation current such that the desired operating speed is continuously variable.

12. The transmission of claim 10, wherein the control unit is further operable to receive data representing engine conditions, and to vary the excitation current in response to the receiving step.

13. The transmission of claim 10, wherein the accessory is an air boosting device.

14. The transmission of claim 10, wherein the accessory is one of the following: water pump, radiator fan, power steering pump, or air conditioning compressor.

15. The transmission of claim 10, further comprising an electric motor connected to the sun gear.

16. The transmission of claim 15, wherein the electric motor is operable to assist in powering the accessory.

17. The transmission of claim 10, wherein the generator is operable to charge a battery.

18. The transmission of claim 10, wherein the engine is an internal combustion engine and the belt is a front belt of the engine.
